(19) United States
(12) Patent Application Publication
(10) Pub. No.: US 2023/0009547 A1
(43) Pub. Date: Jan. 12, 2023

(54) METHOD AND APPARATUS FOR DETECTING OBJECT BASED ON VIDEO, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Xipeng Yang, Beijing (CN); Xiao Tan, Beijing (CN); Hao Sun, Beijing (CN); Errui Ding, Beijing (CN)

(73) Assignee: BEIJING BAIDU NETCOM SCIENCE TECHNOLOGY CO., LTD., Beijing (CN)

(21) Appl. No.: 17/933,271

(22) Filed: Sep. 19, 2022

(30) Foreign Application Priority Data
Sep. 30, 2021 (CN) 202111160338.X

(51) Int. Cl. G06V 10/77; G06V 10/80; G06V 10/764; G06V 10/26

(52) U.S. Cl. CPC G06V 10/7715; G06V 10/806; G06V 10/764; G06V 10/26

(57) ABSTRACT

A method for detecting an object based on a video includes: obtaining a plurality of image frames of a video to be detected; obtaining initial feature maps by extracting features of the plurality of image frames; for each two adjacent image frames of the plurality of image frames, obtaining a target feature map of a latter image frame of the two adjacent image frames by performing feature fusing on the sub-feature maps of the first target dimensions included in the initial feature map of a former image frame of the two adjacent image frames and the sub-feature maps of the second target dimensions included in the initial feature map of the latter image frame; and performing object detection on the respective target feature map of each image frame.

### CROSS REFERENCE TO RELATED APPLICATIONS

This application claims priority and benefits to Chinese Application No. 202111160338.X, filed on Sep. 30, 2021, the entire content of which is incorporated herein by reference.

### TECHNICAL FIELD

The disclosure relates to a field of artificial intelligence technologies, in particular to computer vision and deep learning technologies, which can be applied in target detection and video analysis scenarios, and in particular to a method for detecting an object based on a video, an apparatus for detecting an object based on a video, an electronic device and a storage medium.

### BACKGROUND

In the scenarios of smart city, intelligent transportation and video analysis, accurate detection of objects, such as vehicles, pedestrians, obstacles, lanes, buildings, traffic lights, in a video can provide help for tasks such as abnormal event detection, criminal tracking and vehicle statistics.

### SUMMARY

According to a first aspect of the disclosure, a method for detecting an object based on a video is provided. The method includes:

obtaining a plurality of image frames of a video to be detected;

obtaining initial feature maps by extracting features of the plurality of image frames, in which each initial feature map includes sub-feature maps of first target dimensions and sub-feature maps of second target dimensions;

for each two adjacent image frames of the plurality of image frames, obtaining a target feature map of a latter image frame of the two adjacent image frames by performing feature fusing on the sub-feature maps of the first target dimensions included in the initial feature map of a former image frame of the two adjacent image frames and the sub-feature maps of the second target dimensions included in the initial feature map of the latter image frame; and

performing object detection on a respective target feature map of each image frame.

According to a second aspect of the disclosure, an electronic device is provided. The electronic device includes: at least one processor and a memory communicatively coupled to the at least one processor. The memory stores instructions executable by the at least one processor. When the instructions are executed by the at least one processor, the method for detecting an object based on a video according to the first aspect of the disclosure is implemented.

According to a third aspect of the disclosure, a non-transitory computer-readable storage medium having computer instructions stored thereon is provided. The computer instructions are configured to cause a computer to implement the method for detecting an object based on a video according to the first aspect of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of a method for detecting an object based on a video according to some embodiments of the disclosure.

FIG. 2 is a schematic diagram illustrating feature extraction according to some embodiments of the disclosure.

FIG. 3 is a flowchart of a method for detecting an object based on a video according to some embodiments of the disclosure.

FIG. 4 is a schematic diagram illustrating a generation process of a spliced feature map according to some embodiments of the disclosure.

FIG. 5 is a flowchart of a method for detecting an object based on a video of a third embodiment of the disclosure.

FIG. 6 is a flowchart of a method for detecting an object based on a video according to some embodiments of the disclosure.

FIG. 7 is a schematic diagram illustrating a target recognition model according to some embodiments of the disclosure.

FIG. 8 is a schematic diagram of an apparatus for detecting an object based on a video according to some embodiments of the disclosure.

FIG. 9 is a schematic diagram of an example electronic device that may be used to implement embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Currently, a following object detection technique can be used to detect an object in a video frame: fusing features by enhancing inter-frame detection box (proposal) or inter-frame tokens attention in the video. However, this method cannot fuse sufficient information on all the inter-frame feature information, and does not extract useful features from fused features after all points are fused.

In view of the above problems, the disclosure provides a method for detecting an object based on a video, an apparatus for detecting an object based on a video, an electronic device and a storage medium.

A method for detecting an object based on a video, an apparatus for detecting an object based on a video, an electronic device and a storage medium are described below with reference to the accompanying drawings.

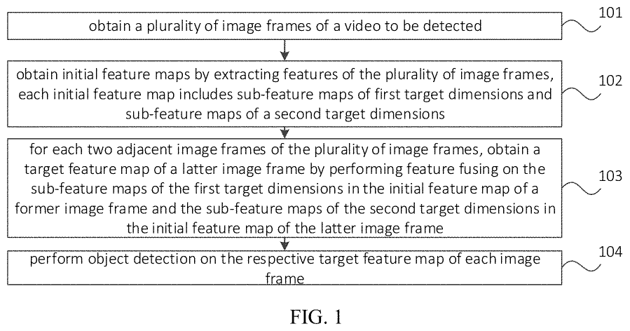

FIG. 1 is a flowchart of a method for detecting an object based on a video according to some embodiments of the disclosure.

For example, the method for detecting an object based on a video is executed by an object detection device. The object detection device can be any electronic device, such that the electronic device can perform an object detection function.

The electronic device can be any device with computing capabilities, such as a personal computer, a mobile terminal and a server. The mobile terminal may be, for example, a vehicle-mounted device, a mobile phone, a tablet computer, a personal digital assistant, a wearable device, and other hardware devices with various operating systems, touch screens and/or display screens.

As illustrated in FIG. 1, the method for detecting an object based on a video includes the following.

In block 101, a plurality of image frames of a video to be detected are obtained.

In embodiments of the disclosure, the video to be detected can be a video recorded online. For example, the video to be detected can be collected online through the web Crawler Technology. Alternatively, the video to be detected can be collected offline. Alternatively, the video to be detected can be a video stream collected in real time. Alternatively, the video to be detected can be an artificially synthesized video. to the method of obtaining the video to be detected is not limited in the disclosure.

In embodiments of the disclosure, the video to be detected can be obtained, and after the video to be detected is obtained, a plurality of image frames can be extracted from the video to be detected.

In block 102, initial feature maps are obtained by extracting features from the plurality of image frames. Each initial feature map includes sub-feature maps of first target dimensions and sub-feature maps of second target dimensions.

In embodiments of the disclosure, for each image frame, feature extraction may be performed to extract features and obtain a respective initial feature map corresponding to the image frame.

In a possible implementation, in order to improve the accuracy and reliability of a result of the feature extraction, the feature extraction may be performed on the image frames based on the deep learning technology to obtain the initial feature maps corresponding to the image frames.

For example, a backbone network can be used to perform the feature extraction on the image frames to obtain the initial feature maps. For example, the backbone can be a residual network (ResNet), such as ResNet 34, ResNet 50 and ResNet 101, or a DarkNet (an open source neural network framework written in C and CUDA), such as DarkNet19 and DarkNet53.

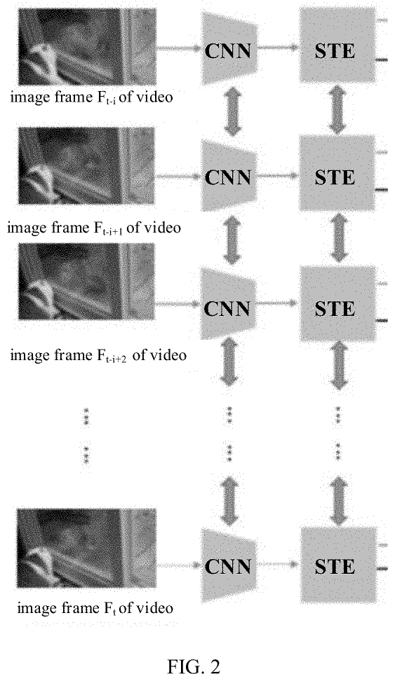

A convolutional neural network (CNN) illustrated in FIG. 2 can be used to extract the features of each image frame to obtain the respective initial feature map. The initial feature maps output by the CNN network can each be a three-dimensional feature map of W (width)×H (height)×C (channel or feature dimension). The term “STE” in FIG. 2 is short for shift.

The initial feature map corresponding to each image frame may include the sub-feature maps of the first target dimensions and the sub-feature maps of the second target dimensions. In the above example, if the value of C is for example 256, the sub-feature maps of the first target dimensions are the sub-feature maps of dimensions from 0 to c included in the initial feature map, while the sub-feature maps of the second target dimensions are the sub-feature maps of dimensions from (c+1) to 255 included in the initial feature map, or the sub-feature maps of the first target dimensions are the sub-feature maps of dimensions from (c+1) to 255 included in the initial feature map, while the sub-feature maps of the second target dimensions are the sub-feature maps of dimensions from 0 to c included in the initial feature map, which is not limited in the disclosure, in which, the value c can be determined in advance.

In a possible implementation, in order to achieve both the accuracy result of the feature extraction and resources saving, a suitable backbone network can be selected to perform the feature extraction on each image frame in the video according to the application scenario of the video service. For example, the backbone network can be classified as a lightweight structure (such as ResNet18, ResNet34 and DarkNet19), a medium-sized structure (such as ResNet50, ResNeXt 50 which is the combination of ResNet and Inception which is a kind of convolutional neural network and DarkNet53), a heavy structure (such as ResNet101 and ResNeXt152). The specific network structure can be selected according to the application scenario.

In block 103, for each two adjacent image frames of the plurality of image frames, a target feature map of a latter image frame of the two adjacent image frames is obtained by performing feature fusing on the sub-feature maps of the first target dimensions included in the initial feature map of a former image frame of the two adjacent image frames and the sub-feature maps of the second target dimensions included in the initial feature map of the latter image frame.

In embodiments of the disclosure, for each two adjacent image frames of the plurality of image frames, features of the sub-feature maps of the first target dimensions included in the initial feature map of the former image frame and features of the sub-feature maps of the second target dimensions included in the initial feature map of the latter image frame are fused to obtain a fused feature map, and the fused feature map is determined as the target feature map of the latter image frame.

It is noteworthy that, there does not have a previous image frame before a first one of image frames in the video to be detected or a first one of the plurality of image frames as a reference, in the disclosure, sub-feature maps of the first target dimensions that are set in advance and the sub-feature maps of the second target dimensions included in the initial feature map of the first one of image frames are fused to obtain a fused feature map, and this fused feature map is determined as the target feature map of the first one of image frames. Alternatively, the sub-feature maps of the first target dimensions included in the initial feature map of any one of the image frames are fused with the sub-feature maps of the second target dimension in the initial feature map of the first one of the image frames to obtain a fused feature map, and this fused feature map is determined as the target feature map of the first one of image frames.

In block 104, object detection is performed based on a respective target feature map of each image frame.

In embodiments of the disclosure, the object detection may be performed according to the respective target feature map of each image frame, to obtain a detection result corresponding to each image frame. For example, the object detection can be performed on the target feature map s of the image frames based on an object detection algorithm to obtain the detection results corresponding to the image frames respectively. The object detection result includes the position of the prediction box and the category of the object contained in the prediction box. The object may be such as a vehicle, a human being, a substance, or an animal. The category can be such as vehicle, or human.

In a possible implementation, in order to improve the accuracy and reliability of the object detection result, the object detection can be performed on the respective target feature map of each image frame based on the deep learning technology, and the object detection result corresponding to each image frame can be obtained.

According to the method for detecting an object based on a video, the initial feature maps are obtained by extracting the features of the plurality of image frames of the video to be detected. Each initial feature map includes the sub-feature maps of the first target dimensions and the sub-feature maps of the second target dimensions. For each two adjacent image frames of the plurality of image frames, the target feature map of the latter image frame of the two adjacent image frames is obtained by fusing the features of the sub-feature maps of the first target dimensions included in the initial feature map of the former image frame of the two adjacent image frames and the features of the sub-feature maps of the second target dimensions included in the initial feature map of the latter image frame. The object detection is performed on the respective target feature map of each image frame. Therefore, the object detection performed on each image frame of the video not only relies to the contents of the corresponding image frame, but also makes a reference to the information carried by image frames adjacent to the corresponding image frame, which can improve the accuracy and reliability of the object detection result.

In order to clearly illustrate how to fuse the features of the sub-feature maps included in the initial feature maps of two adjacent image frames in the above embodiments, the disclosure also provides a method for detecting an object based on a video as follows.

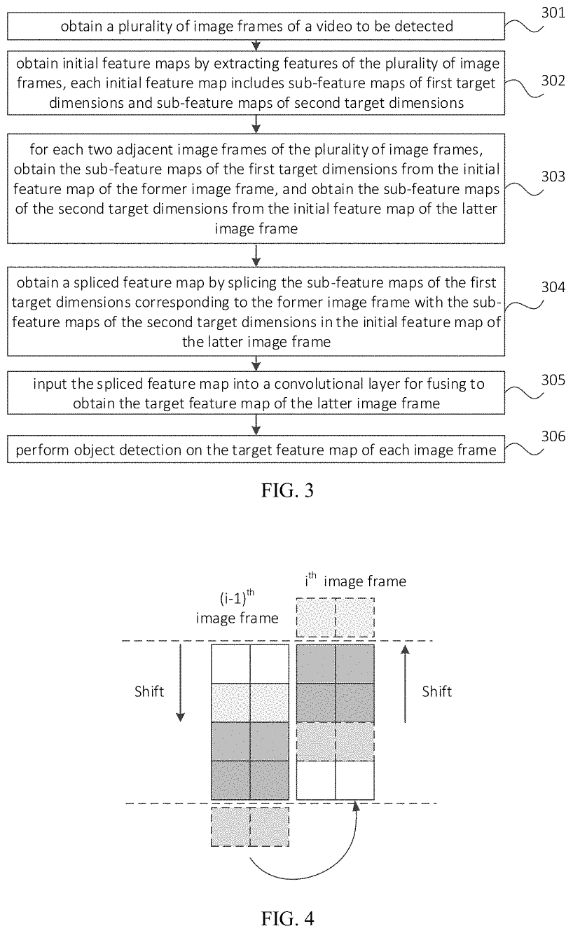

FIG. 3 is a flowchart of a method for detecting an object based on a video according to some embodiments of the disclosure.

As illustrated in FIG. 3, the method for detecting an object based on a video includes the following.

In block 301, a plurality of image frames of a video to be detected are obtained.

In block 302, initial feature maps are obtained by extracting features of the plurality of image frames. Each initial feature map includes sub-feature maps of first target dimensions and sub-feature maps of second target dimensions.

The blocks 301 and 302 are the same as the blocks 101 and 102 in FIG. 1, and details are not described herein.

In block 303, for each two adjacent image frames of the plurality of image frames, the sub-feature maps of the first target dimensions are obtained from the initial feature map of the former image frame of the two adjacent image frames, and the sub-feature maps of the second target dimensions are obtained from the initial feature map of the latter image frame of the two adjacent image frames.

In embodiments of the disclosure, for each two adjacent image frames of the plurality of image frames, the sub-feature maps of the first target dimensions are extracted from the initial feature map of the former image frame, and the sub-feature maps of the second target dimensions are extracted from the initial feature map of the latter image frame.

In a possible implementation, for each two adjacent image frames of the plurality of image frames, sub-features of the first target dimensions are extracted from the initial feature map of the former image frame. The sub-features of the first target dimensions are represented by wᵢ₋₁×hᵢ₋₁×c¹ᵢ₋₁ and the initial feature map of the former image frame is represented by wᵢ₋₁×hᵢ₋₁×cᵢ₋₁, where (i−1) denotes a serial number of the former image frame, wᵢ₋₁ denotes a plurality of width components in the initial feature map of the former image frame, and hᵢ₋₁ denotes a plurality of height components in the initial feature map of the former image frame, cᵢ₋₁ denotes a plurality of dimension components in the initial feature map of the former image frame, and c¹ᵢ₋₁ denotes a fixed number of the first target dimensions at the tail of cᵢ₋₁ In addition, sub-features of the second target dimensions are extracted from the initial feature map of the latter image frame. The sub-features of the second target dimensions are represented by wᵢ×hᵢ×c²ᵢ and the initial feature map of the latter image frame is represented by wᵢ×hᵢ×cᵢ, where i denotes a serial number of the latter image frame, wᵢ denotes a plurality of width components in the initial feature map of the latter image frame, and hᵢ denotes a plurality of height components in the initial feature map of the latter image frame, cᵢ denotes a plurality of dimension components in the initial feature map of the latter image frame, and c²ᵢ denotes a fixed number of the second target dimensions at the head of cᵢ.

For example, the sub-feature maps of the first target dimensions corresponding to the former image frame may be the sub-feature maps of the dimensions from (c+1) to (cᵢ₋₁−1) included in the initial feature map of the former frame image. The sub-feature maps of the second target dimensions corresponding to the latter image frame may be the sub-feature maps of the dimensions from 0 to c included in the initial feature map of the latter image frame. As an example, the value of c is 191, and the value of cᵢ₋₁ is 256. In this case, the sub-feature maps of dimensions from 192 to 255 can be extracted from the initial feature map wᵢ₋₁×hᵢ₋₁×cᵢ₋₁ of the former frame image and the sub-feature maps of dimensions from 0 to 191 can be extracted from the initial feature map wᵢ×hᵢ×cᵢ of the latter image frame.

That is, in the disclosure, the sub-feature maps of multiple dimensions included in the initial feature map of each image frame can be shifted to the right as a whole with respect to the channel dimension, for example, by ¼*channel (that is, 256/4=64), and thus the sub-feature maps of the dimensions from 0 to 191 included in the initial feature map of the former image frame of the two adjacent image frames can be shifted to the dimensions from 64 to 255 of the former image frame, and the sub-feature maps of the dimensions from 192 to 255 included in the initial feature map of the former image frame can be shifted to the dimensions from 0 to 63 of the latter image frame. Similarly, the sub-feature maps of the dimensions from 0 to 191 included in the initial feature map of the latter image frame can be shifted to the dimensions 64 to 255 of the latter image frame, and the sub-feature maps of the dimensions from 192 to 255 included in the initial feature map of the latter image frame can be shifted to the dimensions 0 to 63 dimensions of a next image frame of the latter image frame.

In a possible implementation, the sub-features wᵢ₋₁×hᵢ₋₁×c¹ᵢ₋₁ of the first target dimensions can be extracted from the initial feature map wᵢ₋₁×hᵢ₋₁×cᵢ₋₁ of the former frame image, where c¹ᵢ₋₁ denotes a fixed number of the first target dimensions at the head of cᵢ₋₁ In addition, the sub-features wᵢ×hᵢ×c² of the second target dimensions can be extracted from the initial feature map wᵢ×hᵢ×cᵢ of the latter image frame, where c²ᵢ denotes a fixed number of the second target dimensions at the tail of ci.

For example, the sub-feature maps of the first target dimensions corresponding to the former image frame can be the sub-feature maps of the dimensions from 0 to c included in the initial feature map of the former frame image, and the sub-feature maps of the second target dimensions corresponding to the latter image frame may be the sub-feature maps of the dimensions from (c+1) to (cᵢ₋₁−1) included in the initial feature map of the latter image frame. For example, the value of c is 192 and the value of cᵢ₋₁ is 256. In this case, the sub-feature maps of the dimensions from 0 to 191 can be extracted from the initial feature map wᵢ₋₁×hᵢ₋₁×cᵢ₋₁ of the former image frame, and the sub-feature maps of the dimensions from 192 to 255 can be extracted from the initial feature map wᵢ×hᵢ×cᵢ of the latter image frame.

Therefore, the sub-feature maps of the first target dimensions and the sub-feature maps of the second target dimensions can be determined according to various methods, which can improve the flexibility and applicability of the method.

In block 304, a spliced feature map is obtained by splicing the sub-feature maps of the first target dimensions corresponding to the former image frame with the sub-feature maps of the second target dimensions in the initial feature map of the latter image frame.

In embodiments of the disclosure, the sub-feature maps of the first target dimensions corresponding to the former image frame can be spliced with the sub-feature maps of the second target dimensions in the initial feature map of the latter image frame to obtain the spliced feature map.

In a possible implementation, when the sub-feature maps of multiple dimensions included in the initial feature map of each image frame are shifted to the right with respect to the channel dimension as a whole, that is, when c¹ᵢ₋₁ is a fixed number of first target dimensions at the tail of cᵢ₋₁ and c²ᵢ is a fixed number of the second target dimensions at the head of cᵢ, the sub-feature maps of the second target dimensions included in the initial feature map of the latter image frame are spliced after the sub-feature maps of the first target dimensions corresponding to the former image frame, to obtain the spliced feature map.

In a possible implementation, when the sub-feature maps of multiple dimensions included in the initial feature map of each image frame are shifted to the left as a whole with respect to the channel dimension, that is, when c¹ᵢ₋₁ is a fixed number of the first target dimensions at the head of cᵢ₋₁ and c²ᵢ is a fixed number of the second target dimensions at the tail of cᵢ, the sub-feature maps of the first target dimensions corresponding to the former image frame are spliced after the sub-feature maps of the second target dimensions included in the initial feature map of the latter image frame to obtain the spliced feature map.

As an example, each sub-feature map of each dimension is represented as a square in FIG. 4. After the sub-feature maps of multiple dimensions included in the initial feature map of each image frame are shifted to the right with respect to the channel dimension as a whole, the shifted sub-feature maps (represented by dotted squares) of the (i−1)^{th} image frame are spliced with the sub-feature maps (represented by non-blank squares) corresponding to the i^{th} image frame, that is, the shifted sub-feature maps of the (i−1)^{th} image frame are moved to the positions where the blank squares corresponding to the i^{th} image frame are located to obtain the spliced feature map.

In block 305, the spliced feature map is input into a convolutional layer for fusing to obtain the target feature map of the latter image frame.

In embodiments of the disclosure, a convolution layer (i.e., a cony layer) can be used to perform the feature extraction on the spliced feature map to extract fusion features or the spliced feature map can be fused through a convolution layer to obtain fusion features, so that the fusion features can be determined as the target feature map of the latter image frame.

In block 306, object detection is performed on the respective target feature map of each image frame.

For the execution process of step 306, reference may be made to the execution process of any embodiment of the disclosure, and details are not described herein.

In the method for detecting an object based on a video according to embodiments of the disclosure, the convolution layer is used to fuse the spliced feature map to enhance the fused target feature map, thereby further improving the accuracy and reliability of the target detection result.

In order to clearly illustrate how the object detection is performed according to the target feature map in any of the above embodiments of the disclosure, the disclosure also provides a method for detecting an object based on a video.

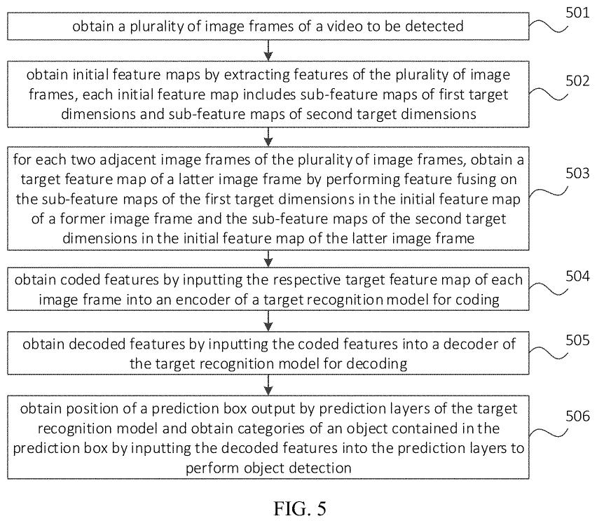

FIG. 5 is a flowchart of a method for detecting an object based on a video according to some embodiments of the disclosure.

As illustrated in FIG. 5, the method for detecting an object based on a video includes the following.

In block 501, a plurality of image frames of a video to be detected are obtained.

In block 502, initial feature maps are obtained by extracting features of the plurality of image frames. Each the initial feature map includes sub-feature maps of first target dimensions and sub-feature maps of second target dimensions.

In block 503, for each two adjacent image frames of the plurality of image frames, a target feature map of a latter image frame of the two adjacent image frames is obtained by performing feature fusing on the sub-feature maps of the first target dimensions included in the initial feature map of a former image frame of the two adjacent image frames and the sub-feature maps of the second target dimensions included in the initial feature map of the latter image frame.

For the execution process of steps 501 to 503, reference may be made to the execution process of any embodiment of the disclosure, and details are not described here.

In block 504, coded features are obtained by inputting the respective target feature map of each image frame into an encoder of a target recognition model for coding.

In embodiments of the disclosure, the structure of the target recognition model is not limited. For example, the target recognition model can be a model with Transformer as a basic structure or a model of other structures, such as a model of a variant structure of Transformer model.

In embodiments of the disclosure, the target recognition model can be trained in advance. For example, an initial target recognition model can be trained based on machine learning technology or deep learning technology, so that the trained target recognition model can learn and obtain a correspondence between the feature maps and the detection results.

In embodiments of the disclosure, for each image frame, the target feature map of the image frame are encoded by an encoder of the target recognition model to obtain the coded features.

In block 505, decoded features are obtained by inputting the coded features into a decoder of the target recognition model for decoding.

In embodiments of the disclosure, the decoder in the target recognition model can be used to decode the encoded features output by the encoder to obtain the decoded features. For example, a matrix multiplication operation can be performed on the encoded features according to the model parameters of the decoder to obtain the Q, K, and V components of the attention mechanism, and the decoded features are determined according to the Q, K, and V components.

In block 506, positions of a prediction box output by prediction layers of the target recognition model and categories of an object contained in the prediction box are obtained by inputting the decoded features into the prediction layers to perform the object detection.

In embodiments of the disclosure, the prediction layers in the target recognition model can be used to perform the object prediction according to the decoded features to obtain the detection result. The detection result includes the positions of the prediction box and the categories of the object contained in the prediction box.

According to the method for detecting an object based on a video according to embodiments of the disclosure, the feature maps of adjacent image frames of the video are fused, to realize the feature expression ability of the enhanced model, thereby improving the accuracy of a model prediction result, that is, improving the accuracy and reliability of the object detection result.

In order to clearly illustrate how to use the prediction layers of the target recognition model to perform the object prediction on the decoded features in the above embodiments, the disclosure also provides a method for detecting an object based on a video.

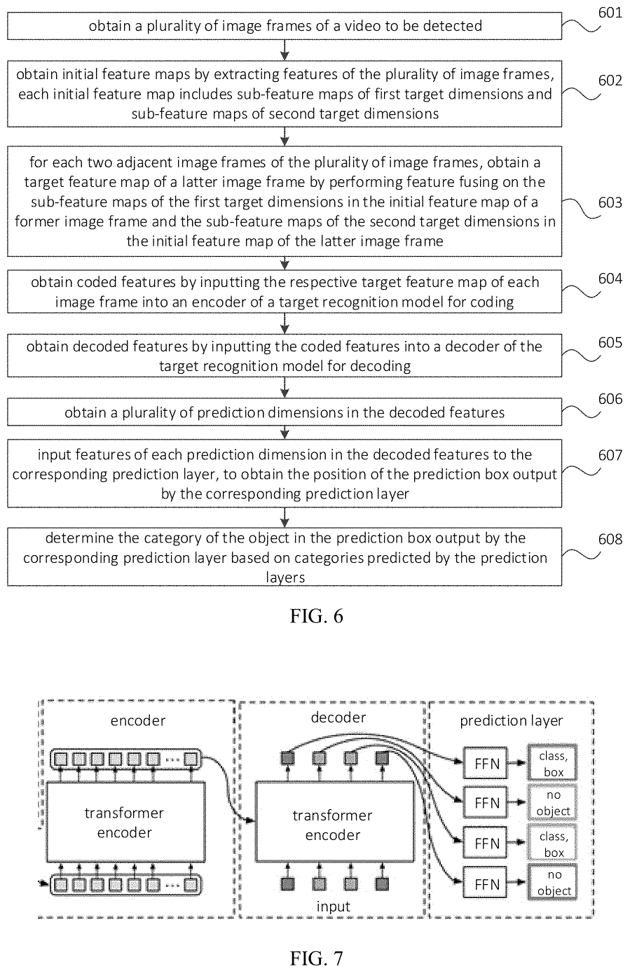

FIG. 6 is a flowchart of a method for detecting an object based on a video according to some embodiments of the disclosure.

As illustrated in FIG. 6, the method for detecting an object based on a video includes the following.

In block 601, a plurality of image frames of a video to be detected are obtained.

In block 602, initial feature maps are obtained by extracting features of the plurality of image frames. Each initial feature map includes sub-feature maps of first target dimensions and sub-feature maps of second target dimensions.

In block 603, for each two adjacent image frames of the plurality of image frames, a target feature map of a latter image frame of the two adjacent image frames is obtained by performing feature fusing on the sub-feature maps of the first target dimensions included in the initial feature map of a former image frame of the two adjacent image frames and the sub-feature maps of the second target dimension included in the initial feature map of the latter image frame.

In block 604, for each image frame, coded features are obtained by inputting the target feature map of the image frame into an encoder of a target recognition model for coding.

In block 605, decoded features are obtained by inputting the coded features into a decoder of the target recognition model for decoding.

For the execution process of steps 601 to 605, reference may be made to the execution process of any embodiment of the disclosure, which is not repeated here.

In block 606, a plurality of prediction dimensions in the decoded features are obtained.

In embodiments of the disclosure, the number of prediction dimensions is related to the number of objects contained in one image frame that can be recognized. For example, the number of prediction dimensions is related to an upper limit value of the number of objects in one image frame that the target recognition model is capable of recognizing. For example, the number of prediction dimensions can range from 100 to 200.

In embodiments of the disclosure, the number of prediction dimensions can be set in advance.

In block 607, features of each prediction dimension in the decoded features are input to a corresponding prediction layer, to obtain the position of the prediction box output by the corresponding prediction layer.

It understandable that the target recognition model can recognize a large number of objects. However, the number of objects recognized by the target recognition model is limited by a framing picture of the image or video frame, where the number of objects contained in the image is limited. In order to take into account the accuracy of the object detection result and to avoid wasting resources, the number of prediction layers can be determined according to the number of prediction dimensions. The number of prediction layers is the same as the number of prediction dimensions.

In embodiments of the disclosure, the features of each prediction dimension in the decoded features are input to the corresponding prediction layer, such that the position of the prediction box output by the corresponding prediction layer is obtained.

In block 608, the category of the object contained in the prediction box output by a corresponding prediction layer is determined based on categories predicted by the prediction layers.

In embodiments of the disclosure, the category of the object contained in the prediction box output by the corresponding prediction layer is determined based on categories predicted by the prediction layers.

As an example, taking the target recognition model as a model with Transformer as the basic structure, the structure of the target recognition model is illustrated in FIG. 7, and the prediction layer is a Feed-Forward Network (FFN).

The target feature map is a three-dimensional feature of H×W×C. The three-dimensional target feature map can be divided into blocks to obtain a serialized feature vector sequence (that is, the fused target feature map is converted into tokens (elements in the feature map), that is, converted into H×W×C-dimensional feature vectors. The serialized feature vectors are input to the encoder for attention learning (the attention mechanism can achieve the effect of inter-frame enhancement), and the obtained feature vector sequence is then input to the decoder, so that the decoder performs attention learning according to the input feature vector sequence. The obtained decoded features are then used for final object detection by FFN, that is, FFN can be used for classification and regression prediction, to obtain the detection result. The box output by FFN is the position of the prediction box, and the prediction box can be determined according to the position of the prediction box. The class output by FFN is the category of the object contained in the prediction box. In addition, no object means there is no object. That is, the decoded features can be input into FFN, the object regression prediction is performed by FFN to obtain the position of the prediction box, and the object category prediction is performed by FFN to obtain the category of the object in the prediction box.

With the method for detecting an object based on a video according to the embodiments of the disclosure, the plurality of prediction dimensions in the decoded features are obtained. The features of each prediction dimension in the decoded feature are input to the corresponding prediction layer, to obtain the position of the prediction box output by the corresponding prediction layer. According to the category predicted by each prediction layer, the category of the object in the prediction box output by the corresponding prediction layer is determined. In this way, the object prediction can be performed on the decoded features according to the multi-layer prediction layers, so that the undetected objects can be avoided, and the accuracy and reliability of the object detection result can be further improved.

Corresponding to the method for detecting an object based on a video according to the embodiments of FIG. 1 to FIG. 6, the disclosure provides an apparatus for detecting an object based on a video. Since the apparatus for detecting an object based on a video according to the embodiments of the disclosure corresponds to the method for detecting an object based on a video according to the embodiments of FIG. 1 to FIG. 6, the embodiments of the method for detecting an object based on a video are applicable to the apparatus for detecting an object based on a video according to the embodiments of the disclosure, which will not be described in detail in the embodiments of the disclosure.

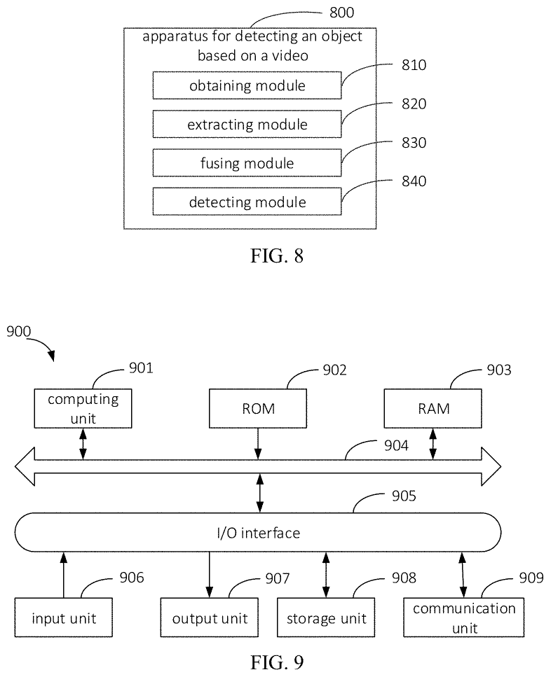

FIG. 8 is a schematic diagram of an apparatus for detecting an object based on a video according to some embodiments of the disclosure.

As illustrated in FIG. 8, the apparatus for detecting an object based on a video 800 may include: an obtaining module 810, an extracting module 820, a fusing module 830 and a detecting module 840.

The obtaining module 810 is configured to obtain a plurality of image frames of a video to be detected.

The extracting module 820 is configured to obtain initial feature maps by extracting features of the plurality of image frames. Each initial feature map includes sub-feature maps of first target dimensions and sub-feature maps of second target dimensions.

The fusing module 830 is configured to, for each two adjacent image frames of the plurality of image frames, obtain a target feature map of a latter image frame of the two adjacent image frames by performing feature fusing on the sub-feature maps of the first target dimensions in the initial feature map of a former image frame of the two adjacent image frames and the sub-feature maps of the second target dimensions in the initial feature map of the latter image frame.

The detecting module 840 is configured to perform object detection on a respective target feature map of each image frame.

In a possible implementation, the fusing module 830 includes: an obtaining unit, a splicing unit and an inputting unit.

The obtaining unit is configured to, for each two adjacent image frames of the plurality of image frames, obtain the sub-feature maps of the first target dimensions from the initial feature map of the former image frame, and obtain the sub-feature maps of the second target dimensions from the initial feature map of the latter image frame.

The splicing unit is configured to obtain a spliced feature map by splicing the sub-feature maps of the first target dimensions corresponding to the former image frame with the sub-feature maps of the second target dimensions included in the initial feature maps of the latter image frame.

The inputting unit is configured to input the spliced feature map into a convolutional layer for fusing to obtain the target feature map of the latter image frame.

In a possible implementation, the obtaining unit is further configured to: extract sub-features of the first target dimensions from the initial feature map of the former image frame, in which the sub-features of the first target dimensions are represented by wᵢ₋₁×hᵢ₋₁×c¹ᵢ₋₁ and the initial feature map of the former image frame is represented by wᵢ₋₁×hᵢ₋₁×cᵢ₋₁, where (i−1) denotes a serial number of the former image frame, wᵢ₋₁ denotes a plurality of width components in the initial feature map of the former image frame, hᵢ₋₁ denotes a plurality of height components in the initial feature map of the former image frame, cᵢ₋₁ denotes a plurality of dimension components in the initial feature map of the former image frame, and c¹ᵢ₋₁ denotes a fixed number of the first target dimensions at the tail of cᵢ₋₁; and extract sub-features of the second target dimensions from the initial feature map of the latter image frame, in which the sub-features of the second target dimensions are represented by wᵢ×hᵢ×c²ᵢ and the initial feature map of the latter image frame is represented by wᵢ×hᵢ×cᵢ, where i denotes a serial number of the latter image frame, wᵢ denotes a plurality of width components in the initial feature map of the latter image frame, hᵢ denotes a plurality of height components in the initial feature map of the latter image frame, cᵢ denotes a plurality of dimension components in the initial feature map of the latter image frame, and c²ᵢ denotes a fixed number of the second target dimensions at the head of cᵢ.

In a possible implementation, the detecting module 840 includes: a coding unit, a decoding unit and a predicting unit.

The coding unit is configured to obtain coded features by inputting the respective target feature map of each image frame into an encoder of a target recognition model for coding.

The decoding unit is configured to obtain decoded features by inputting the coded features into a decoder of the target recognition model for decoding.

The predicting unit is configured to obtain positions of a prediction box output by prediction layers of the target recognition model and obtain categories of an object contained in the prediction box by inputting the decoded features into the prediction layers to perform object detection.

In a possible implementation, the predicting unit is further configured to: obtain a plurality of prediction dimensions in the decoded features; input features of each prediction dimension in the decoded features to the corresponding prediction layer, to obtain the position of the prediction box output by the corresponding prediction layer; and determine the category of the object contained in the prediction box output by the corresponding prediction layer based on categories predicted by the prediction layers.

With the apparatus for detecting an object based on a video, the initial feature maps are obtained by extracting features of the plurality of image frames. Each initial feature map includes the sub-feature maps of the first target dimensions and the sub-feature maps of the second target dimensions. For each two adjacent image frames of the plurality of image frames, the target feature map of the latter image frame is obtained by performing feature fusing on the sub-feature maps of the first target dimensions included in the initial feature map of the former image frame and the sub-feature maps of the second target dimensions included in the initial feature map of the latter image frame. The object detection is performed on the respective target feature map of each image frame. Therefore, the object detection performed on each image frame of the video not only relies to the contents of the corresponding image frame, but also makes a reference to the information carried by image frames adjacent to the corresponding image frame, which can improve the accuracy and reliability of the object detection result.

In order to realize the above embodiments, the disclosure provides an electronic device. The electronic device includes: at least one processor and a memory communicatively coupled to the at least one processor. The memory stores instructions executable by the at least one processor, and when the instructions are executed by the at least one processor, the method for detecting an object based on a video according to any one of the embodiments of the disclosure is implemented.

In order to realize the above embodiments, a non-transitory computer-readable storage medium having computer instructions stored thereon is provided. The computer instructions are configured to cause a computer to implement the method for detecting an object based on a video according to any one of the embodiments of the disclosure.

In order to realize the above embodiments, a computer program product including computer programs is provided. When the computer programs are executed by a processor, the method for detecting an object based on a video according to any one of the embodiments of the disclosure is implemented.

According to the embodiments of the disclosure, the disclosure also provides an electronic device, a readable storage medium and a computer program product.

FIG. 9 is a block diagram of an example electronic device used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the device 900 includes a computing unit 901 performing various appropriate actions and processes based on computer programs stored in a read-only memory (ROM) 902 or computer programs loaded from the storage unit 908 to a random access memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an inputting unit 906, such as a keyboard, a mouse; an outputting unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 901 executes the various methods and processes described above, such as the method for detecting an object based on a video. For example, in some embodiments, the method may be implemented as a computer software program, which is tangibly contained in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the method described above may be executed. Alternatively, in other embodiments, the computing unit 901 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in a cloud computing service system, in order to solve the existing defects of difficult management and weak business expansion in traditional physical hosting and virtual private server (VPS) services. The server can also be a server of a distributed system, or a server combined with a block-chain.

It should be noted that artificial intelligence (AI) is a discipline that allows computers to simulate certain thinking processes and intelligent behaviors (such as learning, reasoning, thinking and planning) of human, which has both hardware-level technology and software-level technology. AI hardware technologies generally include technologies such as sensors, dedicated AI chips, cloud computing, distributed storage, and big data processing. AI software technologies mainly include computer vision technology, speech recognition technology, natural language processing technology, and machine learning/depth learning, big data processing technology, knowledge graph technology and other major directions.

With the technical solution according to embodiments of the disclosure, the initial feature maps are obtained by extracting the features of the plurality of image frames of the video to be detected. Each initial feature map includes the sub-feature maps of the first target dimensions and the sub-feature maps of the second target dimensions. For each two adjacent image frames of the plurality of image frames, the target feature map of the latter image frame of the two adjacent image frames is obtained by fusing the features of the sub-feature maps of the first target dimensions included in the initial feature map of the former image frame of the two adjacent image frames and the features of the sub-feature maps of the second target dimensions included in the initial feature map of the latter image frame. The object detection is performed on the respective target feature map of each image frame. Therefore, the object detection performed on each image frame of the video not only relies to the contents of the corresponding image frame, but also makes a reference to the information carried by image frames adjacent to the corresponding image frame, which can improve the accuracy and reliability of the object detection result.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for detecting an object based on a video, comprising:
obtaining a plurality of image frames of a video to be detected;
obtaining initial feature maps by extracting features of the plurality of image frames, wherein each initial feature map comprises sub-feature maps of first target dimensions and sub-feature maps of second target dimensions;
for each two adjacent image frames of the plurality of image frames, obtaining a target feature map of a latter image frame of the two adjacent image frames by performing feature fusing on the sub-feature maps of the first target dimensions included in the initial feature map of a former image frame of the two adjacent image frames and the sub-feature maps of the second target dimensions included in the initial feature map of the latter image frame; and
performing object detection based on a respective target feature map of each image frame.

2. The method of claim 1, wherein for each two adjacent image frames of the plurality of image frames, obtaining the target feature map of the latter image frame of the two adjacent image frames comprises:
for each two adjacent image frames of the plurality of image frames, obtaining the sub-feature maps of the first target dimensions from the initial feature map of the former image frame, and obtaining the sub-feature maps of the second target dimensions from the initial feature map of the latter image frame;
obtaining a spliced feature map by splicing the sub-feature maps of the first target dimensions corresponding to the former image frame with the sub-feature maps of the second target dimensions included in the initial feature map of the latter image frame; and
inputting the spliced feature map into a convolutional layer for fusing to obtain the target feature map of the latter image frame.

3. The method of claim 2, wherein obtaining the sub-feature maps of the first target dimensions from the initial feature map of the former image frame, and obtaining the sub-feature maps of the second target dimensions from the initial feature map of the latter image frame comprises:
extracting sub-features of the first target dimensions from the initial feature map of the former image frame, wherein the sub-features of the first target dimensions are represented by wᵢ₋₁×hᵢ₋₁×c¹ᵢ₋₁ and the initial feature map of the former image frame is represented by wᵢ₋₁×hᵢ₋₁×cᵢ₋₁, where (i−1) denotes a serial number of the former image frame, denotes a plurality of width components in the initial feature map of the former image frame, hᵢ₋₁ denotes a plurality of height components in the initial feature map of the former image frame, cᵢ₋₁ denotes a plurality of dimension components in the initial feature map of the former image frame, and c¹ᵢ₋₁ denotes a fixed number of the first target dimensions at the tail of cᵢ₋₁; and
extracting sub-features of the second target dimensions from the initial feature map of the latter image frame, wherein the sub-features of the second target dimensions are represented by wᵢ×hᵢ×c²ᵢ and the initial feature map of the latter image frame is represented by wᵢ×hᵢ×cᵢ, where i denotes a serial number of the latter image frame, wᵢ denotes a plurality of width components in the initial feature map of the latter image frame, and hᵢ denotes a plurality of height components in the initial feature map of the latter image frame, cᵢ denotes a plurality of dimension components in the initial feature map of the latter image frame, and c²ᵢ denotes a fixed number of the second target dimensions at the head of cᵢ.

4. The method of claim 1, wherein performing the object detection based on the respective target feature map of each image frame comprises:
for each image frame,
obtaining coded features by inputting the target feature map of the image frame into an encoder of a target recognition model for coding;
obtaining decoded features by inputting the coded features into a decoder of the target recognition model for decoding; and
obtaining positions of a prediction box output by prediction layers of the target recognition model and obtaining categories of the object contained in the prediction box by inputting the decoded features into the prediction layers to perform the object detection.

5. The method of claim 4, wherein obtaining the positions of the prediction box and obtaining the categories of the object contained in the prediction box comprises:
obtaining a plurality of prediction dimensions in the decoded features;
obtaining the position of the prediction box output by a corresponding prediction layer by inputting features of each prediction dimension in the decoded features to the corresponding prediction layer; and
determining the category of the object contained in the prediction box output by the corresponding prediction layer based on a respective category predicted by each prediction layer.

6. An electronic device, comprising:
at least one processor; and
a memory communicatively coupled to the at least one processor; wherein,
the memory stores instructions executable by the at least one processor, when the instructions are executed by the at least one processor, the at least one processor is configured to:
obtain a plurality of image frames of a video to be detected;
obtain initial feature maps by extracting features of the plurality of image frames, wherein each initial feature map comprises sub-feature maps of first target dimensions and sub-feature maps of second target dimensions;
for each two adjacent image frames of the plurality of image frames, obtain a target feature map of a latter image frame of the two adjacent image frames by performing feature fusing on the sub-feature maps of the first target dimensions included in the initial feature map of a former image frame of the two adjacent image frames and the sub-feature maps of the second target dimensions included in the initial feature map of the latter image frame; and
perform object detection based on a respective target feature map of each image frame.

7. The electronic device of claim 6, wherein the at least one processor is configured to:
for each two adjacent image frames of the plurality of image frames, obtain the sub-feature maps of the first target dimensions from the initial feature map of the former image frame, and obtain the sub-feature maps of the second target dimensions from the initial feature map of the latter image frame;
obtain a spliced feature map by splicing the sub-feature maps of the first target dimensions corresponding to the former image frame with the sub-feature maps of the second target dimensions included in the initial feature map of the latter image frame; and
input the spliced feature map into a convolutional layer for fusing to obtain the target feature map of the latter image frame.

8. The electronic device of claim 7, wherein the at least one processor is configured to:
extract sub-features of the first target dimensions from the initial feature map of the former image frame, wherein the sub-features of the first target dimensions are represented by wᵢ₋₁×hᵢ₋₁×c¹ᵢ₋₁ and the initial feature map of the former image frame is represented by wᵢ₋₁×hᵢ₋₁×cᵢ₋₁, where (i−1) denotes a serial number of the former image frame, denotes a plurality of width components in the initial feature map of the former image frame, hᵢ₋₁ denotes a plurality of height components in the initial feature map of the former image frame, cᵢ₋₁ denotes a plurality of dimension components in the initial feature map of the former image frame, and c¹ᵢ₋₁ denotes a fixed number of the first target dimensions at the tail of cᵢ₋₁; and
extract sub-features of the second target dimensions from the initial feature map of the latter image frame, wherein the sub-features of the second target dimensions are represented by wᵢ×hᵢ×c²ᵢ and the initial feature map of the latter image frame is represented by wᵢ×hᵢ×cᵢ, where i denotes a serial number of the latter image frame, wᵢ denotes a plurality of width components in the initial feature map of the latter image frame, and hᵢ denotes a plurality of height components in the initial feature map of the latter image frame, cᵢ denotes a plurality of dimension components in the initial feature map of the latter image frame, and c²ᵢ denotes a fixed number of the second target dimensions at the head of cᵢ.

9. The electronic device of claim 6, wherein the at least one processor is configured to:
for each image frame,
obtain coded features by inputting the target feature map of the image frame into an encoder of a target recognition model for coding;
obtain decoded features by inputting the coded features into a decoder of the target recognition model for decoding; and
obtain positions of a prediction box output by prediction layers of the target recognition model and obtain categories of the object contained in the prediction box by inputting the decoded features into the prediction layers to perform the object detection.

10. The electronic device of claim 9, wherein the at least one processor is configured to:
obtain a plurality of prediction dimensions in the decoded features;
obtain the position of the prediction box output by a corresponding prediction layer by inputting features of each prediction dimension in the decoded features to the corresponding prediction layer; and
determine the category of the object contained in the prediction box output by the corresponding prediction layer based on a respective category predicted by each prediction layer.

11. A non-transitory computer-readable storage medium storing computer instructions, wherein the computer instructions are configured to cause a computer to implement a method for detecting an object based on a video, the method comprising:
obtaining a plurality of image frames of a video to be detected;
obtaining initial feature maps by extracting features of the plurality of image frames, wherein each initial feature map comprises sub-feature maps of first target dimensions and sub-feature maps of second target dimensions;
for each two adjacent image frames of the plurality of image frames, obtaining a target feature map of a latter image frame of the two adjacent image frames by performing feature fusing on the sub-feature maps of the first target dimensions included in the initial feature map of a former image frame of the two adjacent image frames and the sub-feature maps of the second target dimensions included in the initial feature map of the latter image frame; and
performing object detection based on a respective target feature map of each image frame.

12. The non-transitory computer-readable storage medium of claim 11, wherein for each two adjacent image frames of the plurality of image frames, obtaining the target feature map of the latter image frame of the two adjacent image frames comprises:
for each two adjacent image frames of the plurality of image frames, obtaining the sub-feature maps of the first target dimensions from the initial feature map of the former image frame, and obtaining the sub-feature maps of the second target dimensions from the initial feature map of the latter image frame;
obtaining a spliced feature map by splicing the sub-feature maps of the first target dimensions corresponding to the former image frame with the sub-feature maps of the second target dimensions included in the initial feature map of the latter image frame; and
inputting the spliced feature map into a convolutional layer for fusing to obtain the target feature map of the latter image frame.

13. The non-transitory computer-readable storage medium of claim 12, wherein obtaining the sub-feature maps of the first target dimensions from the initial feature map of the former image frame, and obtaining the sub-feature maps of the second target dimensions from the initial feature map of the latter image frame comprises:
extracting sub-features of the first target dimensions from the initial feature map of the former image frame, wherein the sub-features of the first target dimensions are represented by wᵢ₋₁×hᵢ₋₁×c¹ᵢ₋₁ and the initial feature map of the former image frame is represented by wᵢ₋₁×hᵢ₋₁×cᵢ₋₁, where (i−1) denotes a serial number of the former image frame, wᵢ₋₁ denotes a plurality of width components in the initial feature map of the former image frame, hᵢ₋₁ denotes a plurality of height components in the initial feature map of the former image frame, cᵢ₋₁ denotes a plurality of dimension components in the initial feature map of the former image frame, and c¹ᵢ₋₁ denotes a fixed number of the first target dimensions at the tail of cᵢ₋₁; and
extracting sub-features of the second target dimensions from the initial feature map of the latter image frame, wherein the sub-features of the second target dimensions are represented by wᵢ×hᵢ×c²ᵢ and the initial feature map of the latter image frame is represented by wᵢ×hᵢ×cᵢ, where i denotes a serial number of the latter image frame, wᵢ denotes a plurality of width components in the initial feature map of the latter image frame, and hᵢ denotes a plurality of height components in the initial feature map of the latter image frame, cᵢ denotes a plurality of dimension components in the initial feature map of the latter image frame, and c²ᵢ denotes a fixed number of the second target dimensions at the head of cᵢ.

14. The non-transitory computer-readable storage medium of claim 11, wherein performing the object detection based on the respective target feature map of each image frame comprises:
for each image frame,
obtaining coded features by inputting the target feature map of the image frame into an encoder of a target recognition model for coding;
obtaining decoded features by inputting the coded features into a decoder of the target recognition model for decoding; and
obtaining positions of a prediction box output by prediction layers of the target recognition model and obtaining categories of the object contained in the prediction box by inputting the decoded features into the prediction layers to perform the object detection.

15. The non-transitory computer-readable storage medium of claim 14, wherein obtaining the positions of the prediction box and obtaining the categories of the object contained in the prediction box comprises:
obtaining a plurality of prediction dimensions in the decoded features;
obtaining the position of the prediction box output by a corresponding prediction layer by inputting features of each prediction dimension in the decoded features to the corresponding prediction layer; and
determining the category of the object contained in the prediction box output by the corresponding prediction layer based on a respective category predicted by each prediction layer.
